(19) United States
(12) Patent Application Publication
(10) Pub. No.: US 2016/0095168 A1
(43) Pub. Date: Mar. 31, 2016

(54) SYSTEM AND METHOD FOR DETECTING VESSEL PRESENCE FOR AN INDUCTION HEATING APPARATUS

(71) Applicant: General Electric Company, Schenectady, NY (US)

(72) Inventors: Mingwei Shan, Louisville, KY (US); Gregory Francis Gawron, SR., Jeffersontown, KY (US); William Hull Bicknell, Louisville, KY (US); John Michael Kulp, JR., Louisville, KY (US)

(21) Appl. No.: 14/501,084

(22) Filed: Sep. 30, 2014

(51) Int. Cl. H05B 6/06; H05B 6/12

(52) U.S. Cl. CPC H05B 6/062; H05B 6/1209

(57) ABSTRACT

Systems and methods for detecting vessel presence for an induction heating apparatus are disclosed. A detector circuit generates an output signal based on a feedback signal corresponding to a signal, such as current, flowing through an induction heating coil. The output signal has low frequency components that are averaged over multiple integer periods and compared to a reference value to determine the presence or absence of a vessel on the induction heating coil.

### FIELD OF THE INVENTION

The present disclosure relates to induction heating and more particularly to a system and method for detection of the presence of a pan or other vessel for an induction heating apparatus, such as a cooktop.

### BACKGROUND OF THE INVENTION

Induction cooktops are used to heat cooking utensils by magnetic induction. In general, a resonant power inverter is used in such cooktops to supply a chopped DC power signal through a heating coil. This generates a magnetic field, which is magnetically coupled to a conductive object or vessel, such as a pan, placed over the heating coil. The magnetic field generates eddy currents in the vessel, causing the vessel to heat.

A typical half-bridge resonant power inverter circuit is illustrated in FIG. 1. As shown, the induction heating coil 114 receives a power signal 101 that is supplied through a resonant power inverter 112. The resonant inverter module 112 is generally configured to generate a high frequency power signal from an AC source at the required operating frequency to the induction heating coil 114. The load of the resonant inverter module 112 generally includes the induction heating coil 114 and any object or vessel that is present on the induction heating coil 114. The object or vessel on the induction heating coil 114, such as for example a pan, will be generally referred to herein as a vessel.

In general, resonant inverter module 112 is provided with switching devices 116 and 118, which are controlled in a known manner by controller 120 and switching unit 130 to provide power to the load, including the induction heating coil 114 and any vessel or object thereon. In typical known applications, controller 120 can be configured to control switching unit 130 based on signals from a current transducer or current transformer 110.

It is advantageous to operate the resonant power inverter at resonance or above resonance for several reasons. For instance, as previously noted, operating at resonance provides maximum power transfer between the induction heating coil and the vessel on the induction heating coil. If, on the other hand, reduced power on the induction heating coil is desired, it is advantageous to drive the frequency above resonance. Operating below resonance results in greater switching losses, leading to reduced efficiency. Moreover, operating below resonance risks entering into the human audible hearing range, leading to undesirable operating conditions.

FIG. 2 illustrates a typical quasi-resonant power inverter circuit 230. As illustrated, induction heating coil 214 receives power from an AC source 210 by way of a rectifier 212 and controlled by operation of a switching device 290. Switching device 290 in turn is controlled by controller 220 which provides control signals to switching device 290 based, at least in part, on the current flowing through a Shunt device 240, more generally, based on the voltage drop across the shunt device.

In general, switching device 290 corresponds to the active component of a quasi-resonant inverter module which is controlled in a known manner by controller 220 to provide power to the load, including the induction heating coil 214 and any vessel or object thereon.

FIG. 3 provides a graphical depiction of the desirable operating range for a resonant power inverter for supplying chopped DC power to an induction heating coil. As indicated by curve 300, maximum power is achieved at resonant frequency. Reduced power occurs at frequencies further from the resonant frequency. FIG. 3 illustrates that the desired operating range is at or above the resonant frequency for the resonant power inverter. Dropping below resonant frequency can lead to inefficient operation of the resonant power circuit, as well as entering into the human audible hearing range.

There are multiple methods for detection of an object or vessel on an induction cooktop. Some of these methods include the use of mechanical switching, phase detection, optical sensing and harmonic distortion sensing. Each of these methods is, however, subject to certain disadvantages. For example, mechanical and optical detectors may be adversely affected by debris associated with the cooktop. Similarly, phase and harmonic distortion methodologies may require relatively expensive processing devices. In some systems, these detection methods use a current transformer to detect the resonant voltage. However current transformer packages tend to have large package sizes and footprints, and can be expensive.

Thus, a need exists for system and method for detection of the presence of a vessel for an induction heating apparatus that overcomes the above mentioned disadvantages.

### BRIEF DESCRIPTION OF THE INVENTION

Aspects and advantages of the invention will be set forth in part in the following description, or may be obvious from the description, or may be learned through practice of the invention.

One exemplary embodiment of the present disclosure is directed to an induction heating system. Such induction heating system includes an induction heating coil operable to inductively heat a load with a magnetic field, a power supply circuit configured to supply a power signal to the induction heating coil at a relatively high operating frequency, and a detector circuit configured to detect a feedback signal corresponding to a signal flowing through said induction heating coil. The detector circuit provides an output signal having an amplitude dependent on the presence of a vessel proximate the induction heating coil. In selected embodiments, the feedback signal is filtered to minimize high frequency components to provide a relative low frequency ripple signal to a comparator to determine vessel presence. In other selected embodiments, the ripple signal may be averaged over multiple integer periods of the low frequency before being sent to the comparator.

Another exemplary embodiment of the present disclosure is directed to a method. The method includes detecting a feedback signal in an induction heating apparatus. According to such method, the feedback signal corresponds to a signal flow through an induction heating coil of an induction heating apparatus. In accordance with selected embodiments of the method, a feedback signal is compared to a reference signal to generate an output signal having an amplitude dependent on the presence of a vessel proximate an induction heating coil. In other selected embodiments of the method, the feedback signal may be further processed using averaging techniques, including in some embodiments, averaging over multiple integer periods, before comparing the feedback signal to a reference.

A further exemplary embodiment of the present disclosure is directed to an induction heating system. The induction heating system includes an induction heating coil operable to inductively heat a load with a magnetic field, an inverter circuit configured to supply a chopped DC power signal to the induction heating coil at an operating frequency, wherein the inverter circuit comprises one or more switching devices that are configured to control current through the induction heating coil, and a detector circuit configured to detect a feedback signal corresponding to a current flowing through the induction heating coil. The detector circuit provides an output signal having an output amplitude dependent on the presence of a vessel proximate the induction heating coil. The induction heating system may also include a controller configured to control the inverter circuit based at least in part on the amplitude of the output signal of the detector circuit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a circuit diagram of a typical known half-bridge resonant power inverter circuit for supplying power to an induction heating coil;

FIG. 2 provides a circuit diagram of a typical known quasi-resonant power inverter circuit for supplying power to an induction heating coil;

FIG. 3 provides a graphical depiction of the desirable operating frequency range for a resonant power inverter for supplying power to an induction heating coil;

FIG. 4 provides a block diagram of an induction heating system according to an exemplary embodiment of the present disclosure;

FIG. 5 provides a circuit diagram of a quasi-resonant induction heating system according to an exemplary embodiment of the present disclosure;

FIG. 6 provides a graphical depiction of feedback signal across a shunt resistor in a return path of the current flowing through an induction heating coil with a vessel present according to an exemplary embodiment of the present disclosure;

FIG. 7 provides a graphical depiction of feedback signal across a shunt resistor in a return path of the current flowing through an induction heating coil without a vessel present according to an exemplary embodiment of the present disclosure; and

FIG. 8 provides a flow diagram of an exemplary method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

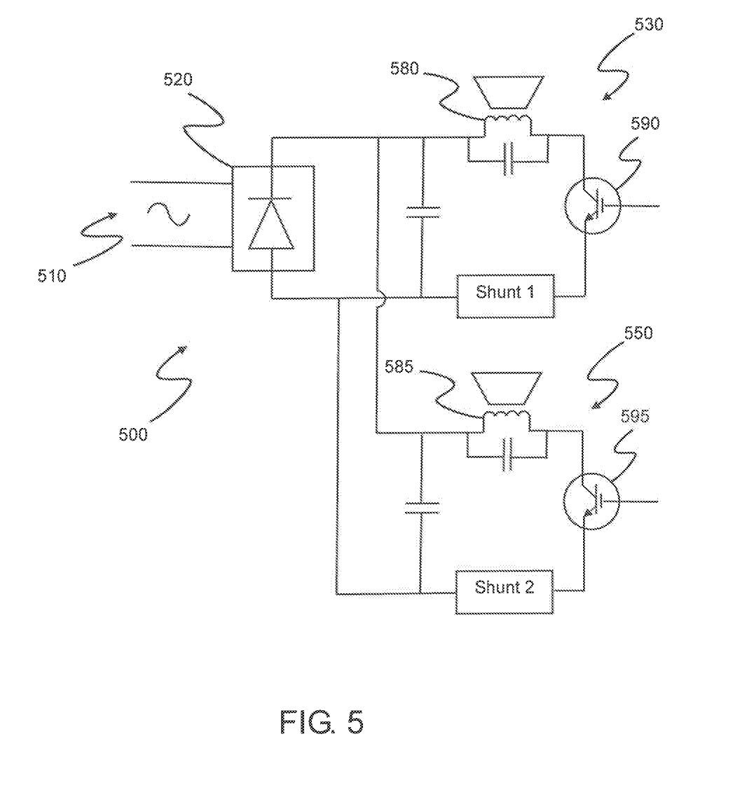

Generally, the present disclosure is directed to a system and method for detecting the presence or absence of a ferromagnetic vessel proximate an induction coil of a cooktop. The provision of such a method in the operational schema of an induction cooktop is highly significant to the proper operation of an induction burner of such a cooktop. A circuit operating in accordance with such a method is used to determine the presence (and absence) of a ferromagnetic material in proximity of the induction cooking coil. In accordance with a particularly significant aspect of the present subject matter, the method herein disclosed can be employed in a multi-burner cooktop to detect each individual vessel controlled by its corresponding inverter coupled after a common rectifier bridge. This aspect of the present subject matter is illustrated more fully in FIG. 5 to be described more fully herein after.

The systems and methods of the present disclosure are described generally with reference to an induction cooking apparatus. Those of ordinary skill in the art, using the disclosures provided herein, should, however, understand that the systems and methods of the present disclosure are more broadly applicable to many resonant power supply technologies.

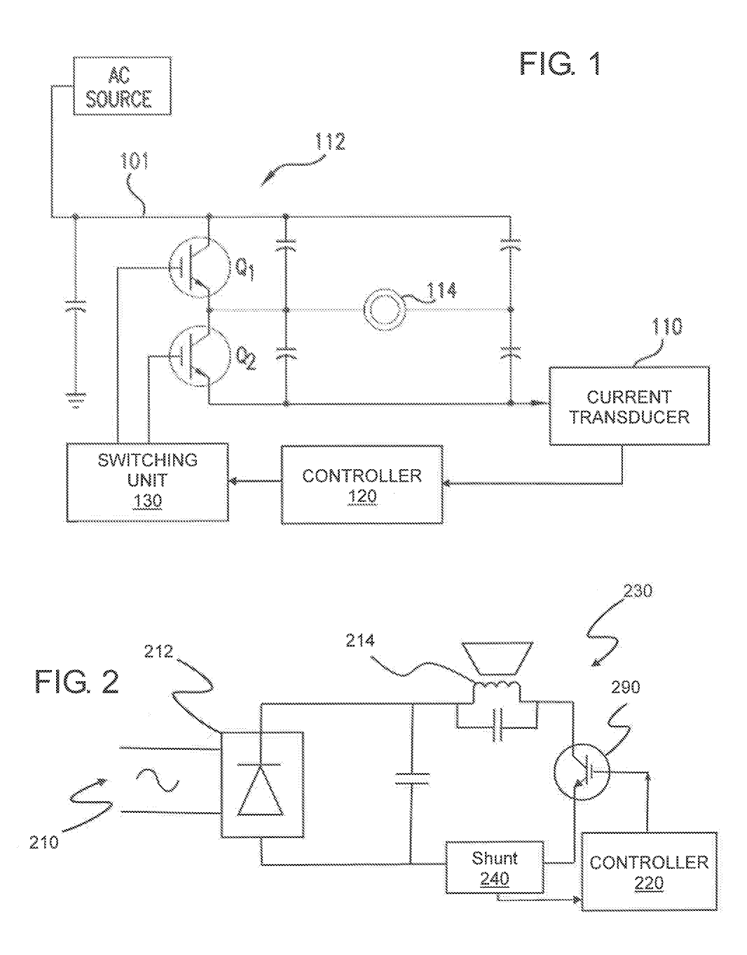

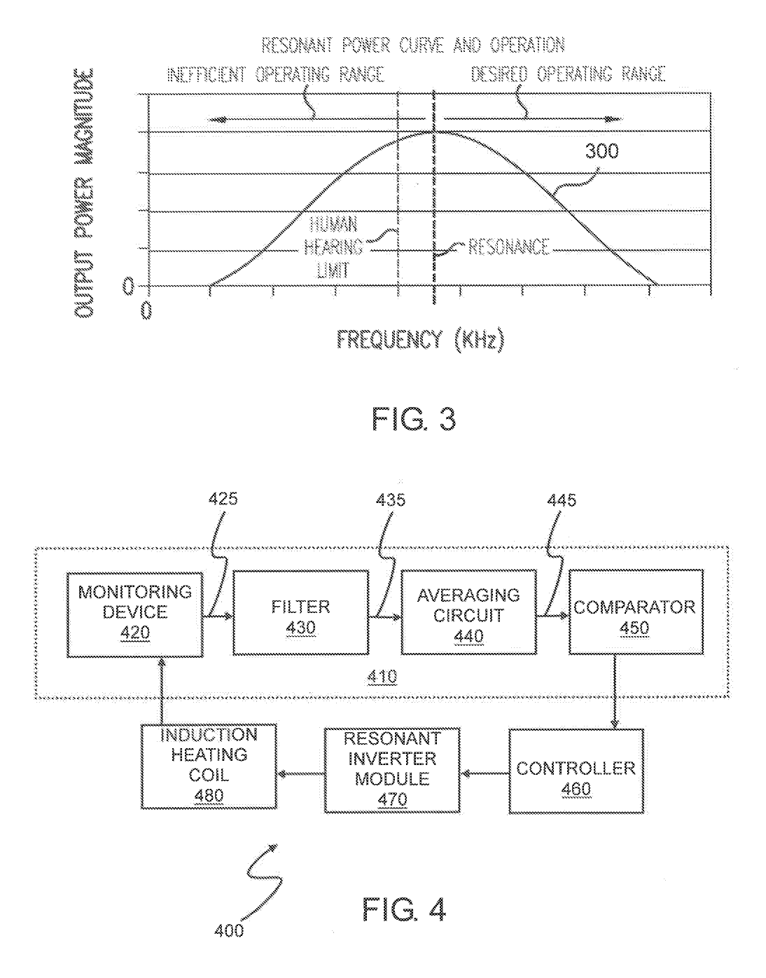

Referring more particularly to the presently disclosed subject matter and with reference to FIG. 4, it will be seen that there has been provided in such figure a schematic block diagram of an induction heating system 400 according to an exemplary embodiment of the present disclosure. Induction heating system 400 includes a detection circuit 410, a controller 460, a power supply circuit such as resonant inverter module 470, and an induction heating coil 480. The resonant inverter module 470 is configured to supply a chopped DC power signal to induction heating coil 480 at a desired operating frequency. The topology of the resonant inverter module 470 can be similar to the known half-bridge resonant inverter topology depicted in FIG. 1. Alternatively, as will be described more fully later with respect to FIG. 5, the presently disclosed subject matter may equally well be employed in association with a quasi-resonance topology as illustrated in FIG. 5.

Referring still to FIG. 4, the detection circuit 410 includes a monitoring device 420 that is configured to detect and measure a current flow through induction heating coil 480. Monitoring device 420 generates a feedback signal 425 based on the current flow through the induction heating coil 480. In accordance with the present subject matter, monitoring device 420 may correspond to a shunt resistor as will be more fully described later with reference to FIG. 5 and the feedback signal may correspond to a voltage measured across the shunt resistor.

In accordance with the present subject matter, feedback signal 425 generally corresponds to a high frequency signal and an accompanying low frequency ripple component. The high frequency component resulting from the high frequency signals applied to induction heating coil 480 and the low frequency component resulting from rectification of applied power from a power source, for example a 60 Hz power system. Generally the ripple frequency produced from a 60 Hz power source will correspond to a 120 Hz ripple frequency. Filter 430 is configured to remove the high frequency portion of signal 425 from monitoring device 420 and to pass the relatively lower ripple frequency, for example 120 Hz, to an averaging circuit 440 via signal line 435.

In accordance with a significant aspect of the present subject matter, filtered feedback signal 425 is then averaged within averaging circuit 440 over integer multiple periods of the ripple frequency to obtain a shunt average current 445. Shunt average current 445 is then compared in comparator 450 to a predetermined value. If shunt average current 445 is less than the predetermined value, the output of comparator 450 will then indicate that there is no vessel present on induction heating coil 480. If, on the other hand, the shunt average current 445 is equal to or above the predetermined value, the output of comparator 450 will indicate that a vessel is present. Those of ordinary skill in the art, using the disclosures provided herein, will understand that other signal conditioning devices, such as amplifiers, etc., can be used to condition the feedback signal for processing.

An output signal from comparator 450 provides information to controller 460 regarding the presence of a vessel in proximity to induction heating coil 480. With such information controller 460 can then be configured to control the resonant inverter module 470 based at least in part on the output signal of the detection circuit 410.

With reference to FIG. 5, there is illustrated a circuit diagram of an exemplary quasi-resonant induction heating system 500 that is configured to monitor feedback signals from individual shunt resistors, Shunt 1, Shunt 2, in the return paths of current flowing through individual induction heating coils 580, 585 in a dual burner cooktop appliance. It should be appreciated that more than two, for example, four, burners may be provided in system 500 as may be desirable. As illustrated, system 500 includes a single rectifier bridge 520 that is configured to provide rectified power from source 510 to a pair of individual burner circuits 530, 540. Individual burner circuits 530, 540 may be individually controlled by controllable switching devices 590, 595, respectively. Controllable switching devices 590, 595 may correspond to IGBTs as previously described and may be individually controlled from a single controller, e.g., controller 460 of FIG. 4.

It is an important aspect of the present subject matter that the functions of the filter 420, averaging circuit 440, comparator 450, and controller 460 may all be provided by way of a low-end microcontroller. Since the method of the present subject matter does not require high speed sampling as might have been required if samples from the high frequency pulses were required, a low-end microcontroller is well suited for use with the present subject matter. Such low-end microcontroller may be employed either for only the signal processing aspects of the present subject matter or may also be employed to control other operating aspects of the cooktop, for example, operation of the individual burner circuits in a multiburner cooktop. Further, it should be appreciated that the signal processing features of the present subject matter may be provided by way of discrete component systems, for example, integrated circuit filters, comparators, etc. as would be apparent to those of ordinary skill in the art.

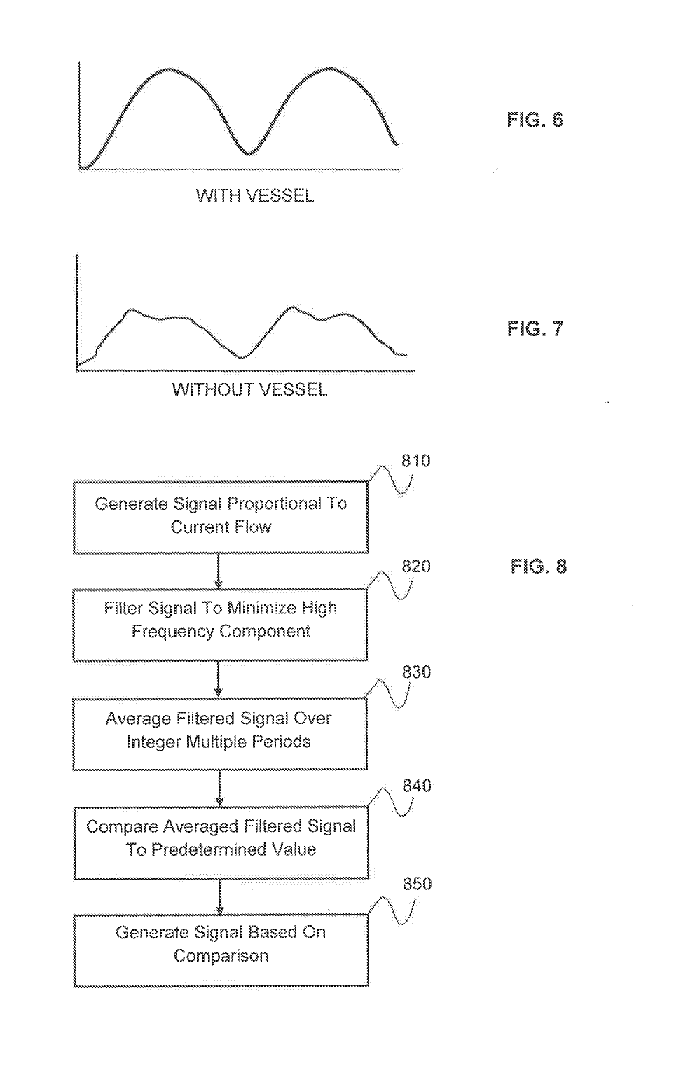

FIG. 6 illustrates an exemplary plot of a feedback signal 435 across a shunt resistor, for example Shunt 1 or Shunt 2 of FIG. 5, in the instance that a vessel is present in proximity to the induction heater coil. As illustrated in FIG. 6, the high frequency component of the signal has been removed by filter 430 (FIG. 4). Upon taking an average of such a signal over integer multiple periods of such waveform, the average will be relative high exceeding a predetermined value and will indicate that a vessel is present.

FIG. 7 illustrates an exemplary plot of a feedback signal 435 across a shunt resistor, for example Shunt 1 or Shunt 2 of FIG. 5, in the instance that a vessel is not in proximity to the induction heater coil. Again in a manner similar to that illustrated in FIG. 6, the high frequency component of the signal has been removed by filter 430, but in this instance the signal due to the absence of a proximate vessel is distorted. This distorted signal when averaged over integer multiple periods will produce a value that is less than a predetermined value and will thereby indicate that a vessel in not present.

FIG. 8 provides a flow diagram of an exemplary method according to an exemplary embodiment of the present disclosure. As illustrated, an exemplary method in accordance with the present subject matter for providing an indication of the presence of a vessel in an induction cooktop begins at step 810 wherein a signal proportional to current flow in the induction coil of an induction cooktop is generated. In exemplary embodiments of the present subject matter, such signal may be generated based on measurement of the voltage drop across a shunt (low value) resistor in series circuit relation to the inductor coil of the cooktop. Alternative methods may, of course, be employed including, without limitation, the use of a Hall effect sensor to measure current flow or the use of a transformer arrangement or combinations of such devices and elements.

In step 820 of the exemplary method, the signal generated in step 810 is filtered to minimize any high frequency components that may be present. Such high frequency components may be generated from the normal operation of, for example, pulse width modulators used in conjunction with the controlled energization of the induction heating coil of an induction cooktop burner. The method provides for filtering out, or at least minimizing, high frequency signals so that underlying lower frequency ripple frequencies associated with operation of an inverter portion of the induction cooktop may be evaluated.

At step 830 the filtered signal produced in step 820 is processed so as to produce an average value of the signal over multiple integer periods of the low frequency ripple portion of the signal measured in step 810. At step 840 the average value of the signal produced in step 830 is compared to a predetermined value. The method recognizes that such a comparison is effective to indicate the presence (or absence) of a vessel proximate the induction coil of an induction cooktop. In particular, if the comparison determines that the average value is above the predetermined value, the method determines that a vessel is present. On the other hand, if the method finds that the average value is equal to or less than the predetermined value, the method determines that a vessel is not present. At step 850 the method in accordance with the present subject matter generates a signal based on the comparison made in step 840, which signal may then be used to at least partially control the operation of the induction cooktop.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction heating system, comprising:
an induction heating coil operable to inductively heat a load with a magnetic field;
a power supply circuit configured to supply a power signal to said induction heating coil at a relatively high operating frequency; and
a detector circuit configured to detect a feedback signal corresponding to a signal flowing through said induction heating coil, said detector circuit providing an output signal having an amplitude dependent on the presence of a vessel proximate said induction heating coil, the amplitude of the output signal determining vessel presence.

2. The induction heating system of claim 1, wherein said detector circuit comprises a shunt resistor in a path of the signal flowing through said induction heating coil, said feedback signal comprising a voltage across said shunt resistor.

3. The induction heating system of claim 1, wherein said detector circuit further includes a filter configured to minimize the relatively high frequency signal components of the feedback signal and to pass relatively low frequency ripple components of the feedback signal.

4. The induction heating system of claim 3, wherein said detector circuit further comprises an averaging circuit configured to average the relatively low frequency ripple components of the feedback signal and a comparator configured to compare the averaged relatively low frequency ripple components of the feedback signal feedback signal to a reference signal, the output of said comparator comprising the output signal of said detector circuit.

5. The induction heating system of claim 4, wherein said averaging circuit is configured to average the relatively low frequency ripple components of the feedback signal over multiple integer periods of the low frequency.

6. The induction heating system of claim 5, wherein said output signal of said detector circuit is provided to a controller, said controller configured to control said power supply circuit based at least in part on said output signal.

7. The induction heating system of claim 6, wherein said controller is configured to control operation of said induction heating coil based at least in part on said output signal.

8. The induction heating system of claim 7, wherein said controller is configured to permit continued operation of said induction heating coil when the comparator determines that the averaged relatively low frequency ripple components of the feedback signal feedback signal is above a predetermined value.

9. The induction heating system of claim 1, wherein said power supply circuit comprises a quasi-resonant inverter circuit.

10. The system of claim 1, wherein said power supply circuit comprises a resonant inverter circuit.

11. A method comprising:
detecting a feedback signal in an induction heating apparatus, the feedback signal corresponding to a signal flow through an induction heating coil of the induction heating apparatus; and
comparing the feedback signal to a reference signal to generate an output signal having an amplitude dependent on the presence of a vessel proximate said induction heating coil, the amplitude of the output signal determining vessel presence.

12. The method of claim 10, wherein the feedback signal comprises a voltage across a shunt resistor in a path of the signal flowing through the induction heating coil.

13. The method of claim 10, further comprising filtering the feedback signal to minimize relatively high frequency components of the feedback signal and to pass relative low frequency ripple components of the feedback signal.

14. The method of claim 13, wherein the method further comprises averaging the relatively low frequency ripple components, comparing the average to a reference signal, and controlling the induction heating apparatus based at least in part on the comparison of the average to the reference signal.

15. The method of claim 14, wherein averaging is performed over multiple integer periods of the low frequency ripple frequency.

16. The method of claim 14, further comprising permitting operation of the induction heating coil when the averaged relatively low frequency ripple components of the feedback signal feedback signal is above a predetermined value.

17. An induction heating system, comprising:
an induction heating coil operable to inductively heat a load with a magnetic field;
an inverter circuit configured to supply a chopped DC power signal to said induction heating coil at an operating frequency, said inverter circuit comprising one or more switching devices configured to control current through said induction heating coil; and
a detector circuit configured to detect a feedback signal corresponding to a current flowing through said induction heating coil, said detector circuit providing an output signal having an amplitude dependent on the presence of a vessel proximate said induction heating coil, the amplitude of the output signal determining vessel presence; and
a controller configured to control said inverter circuit based at least in part on the amplitude of the output signal of said detector circuit.

18. The system of claim 17, wherein said wherein said detector circuit comprises a shunt resistor in a path of the signal flowing through said induction heating coil, said feedback signal comprising a voltage across said shunt resistor.

19. The induction heating system of claim 18, wherein said detector circuit further includes a filter configured to minimize the relatively high frequency signal components of the feedback signal and to pass relatively low frequency ripple components of the feedback signal.

20. The induction heating system of claim 19, wherein said detector circuit further comprises an averaging circuit configured to average the relatively low frequency ripple components of the feedback signal over multiple integer periods of the low frequency, and a comparator configured to compare the averaged relatively low frequency ripple components of the feedback signal feedback signal to a reference signal, an output of said comparator comprising the output signal of said detector circuit.
